(19) United States
(12) Patent Application Publication
(10) Pub. No.: US 2005/0267713 A1
(43) Pub. Date: Dec. 1, 2005

(54) Data acquisition system for generating operator-indexed information

(75) Inventors: Robert Ahern Horkavi, Dunlap, IL (US); Gary Lee Spadin, Chillicothe, IL (US); Steven Wayne O'Neal, Bartonville, IL (US); Michael David Staub, Peoria, IL (US); Adam Johann Gudat, Chillicothe, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/048,853

(22) Filed: Feb. 3, 2005

Related U.S. Application Data
(60) Provisional application No. 60/574,585, filed on May 27, 2004.

(51) Int. Cl. G06F 15/00

(52) U.S. Cl. 702/188

(57) ABSTRACT

A data acquisition system for a work machine has at least one sensor disposed on the work machine. The at least one sensor is configured to produce a signal indicative of an operating parameter of the work machine. The data acquisition system also has an identification module disposed on the work machine and configured to receive an input corresponding to a machine operator. The data acquisition system further has a controller disposed on the work machine and in communication with the at least one sensor and the identification module. The controller is configured to record and link the signal and the input. The data acquisition system additionally has a communication module disposed on the work machine and in communication with the controller. The communication module is configured to transfer the recorded and linked signal and input from the controller to an off-board system.

### RELATED APPLICATIONS

The present disclosure claims the right to priority based on U.S. Provisional Patent Application No. 60/574,585 filed May 27, 2004.

### TECHNICAL FIELD

The present disclosure claims the right to priority based on U.S. Provisional Patent Application No. 60/574,585 filed May 27, 2004. The present disclosure relates generally to a data acquisition system, and more particularly, to a data acquisition system for generating operator-indexed information.

### BACKGROUND

Work machines such as, for example, wheel loaders, track type tractors, on-highway trucks, and other types of machinery are often equipped with sensors for measuring operating conditions of the work machine. These operating conditions may include, for example, engine RPM, oil pressure, water temperature, boost pressure, oil contamination, electric motor current, hydraulic pressure, system voltage, fuel consumption, payload, ground speed, transmission ratio, cycle time, and the like. Storage devices may be provided on the work machine to compile an operating condition database for later evaluation of machine performance.

When evaluating the information stored within the operating condition database to determine work machine performance, it may be beneficial to link work machine performance to particular machine operators. For example, a single work machine within a fleet at a work site may be operated by a number of different operators. These different operators may utilize the work machine during different times of the day, for different periods of time, and/or for different activities. A first operator may be more efficient or productive at performing a particular task with the work machine than a second operator. Likewise, the second operator may be better suited for performing other tasks. Without automatically associating a particular operator with various captured operating conditions, however, it may be difficult to recognize these differences.

In addition, a particular rental work machine at a common work site may be shared between operators who are financially supported by different organizations. Without automatically associating a particular operator with specific work machine parameters, it may be difficult to properly direct rental time fees, fuel costs, repair fees, and other associated charges to the correct organization.

One system that tracks work machine operating conditions is described in U.S. Pat. No. 5,463,567 (the '567 patent) by Boen et al., issued on Oct. 31, 1995. The '567 patent describes a machine monitoring system for providing historical data regarding machine operating parameters. The machine monitoring system includes a plurality of sensors for producing signals indicative of the level of machine parameters. A control is included for processing the selected data to provide an indication of machine performance.

Although the machine monitoring system of the '567 patent may allow for evaluation of machine performance, the machine monitoring system does not link machine performance to a particular machine operator. In addition, the machine monitoring system of the '567 patent may not be flexible enough to allow a machine operator to determine which operating parameters should be monitored, how often they should be monitored, and how often they should be reported.

The disclosed system is directed to overcoming one or more of the problems set forth above.

### SUMMARY OF THE INVENTION

In one aspect, the present disclosure is directed to a data acquisition system for a work machine that includes at least one sensor disposed on the work machine. The at least one sensor is configured to produce a signal indicative of an operating parameter of the work machine. The data acquisition system also includes an identification module disposed on the work machine and configured to receive an input corresponding to a machine operator. The data acquisition system further includes a controller disposed on the work machine and in communication with the at least one sensor and the identification module. The controller is configured to record and link the signal and the input. The data acquisition system additionally includes a communication module disposed on the work machine and in communication with the controller. The communication module is configured to transfer the recorded and linked signal and input from the controller to an off-board system.

In another aspect, the present disclosure is directed to a method of acquiring data for a work machine. The method includes sensing a plurality of operating parameters of the work machine and receiving an input corresponding to a machine operator. The method also includes recording and linking the plurality of operating parameters and the input and transferring the recorded and linked plurality of operating parameters and input to an off-board system.

### BRIEF DESCRIPTION OF THE DRAWINGS

FIG. 1 is a schematic illustration of a data acquisition system according to an exemplary disclosed embodiment.

### DETAILED DESCRIPTION

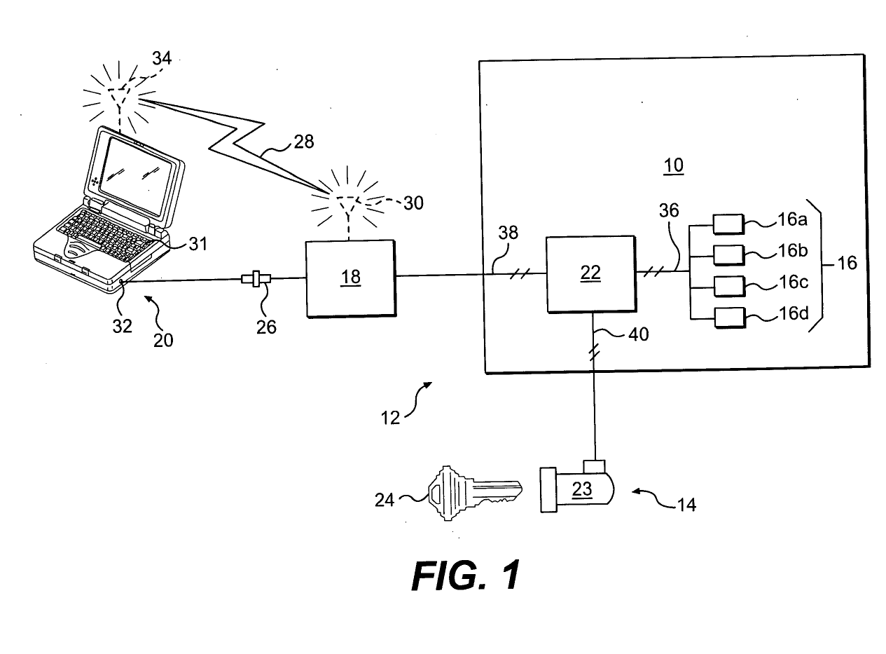

FIG. 1 illustrates a work machine 10 having an exemplary embodiment of a data acquisition system 12. Work machine 10 may be a fixed or mobile machine that performs some type of operation associated with an industry such as mining, construction, farming, or any other industry known in the art. For example, work machine 10 may be an earth moving machine, a generator set, a pump, a marine vessel, an aircraft, or any other suitable operation-performing machine. Data acquisition system 12 may include an identification module 14, an interface module 16, a communication module 18 configured to communicate with an off-board system 20, and a controller 22. It is contemplated that one or more of identification module 14, interface module 16, communication module 18, and controller 22 may be integrated as a single unit.

Identification module 14 may include any means for receiving an operator identification code and generating a signal indicative of the code. Such means may include, for example, a switch 23 configured to receive a coded key 24 having magnetic information on key 24 or a memory chip embedded in key 24, a keypad allowing the code to be manually entered by an operator, a data port allowing direct communication with a service tool or a computer having the code, an antenna allowing reception of the code from a remote location, a scanner configured to read coded indicia, or any other configuration that can receive the code and generate a signal indicative of the code. A code, for the purposes of the present disclosure, may include a configuration of letters, numbers, symbols, pulses, voltage levels, indicia, signals, magnetic fields, sound or light waves, and other configurations that represent an assigned meaning. The code may take the form of one or more of human readable information and machine readable information. It is contemplated that identification module 14 may receive additional pieces of coded information other than an operator identification code.

Interface module 16 may include a plurality of sensors 16a-d distributed throughout the work machine and configured to gather data from various components and subsystems of work machine 10. It is contemplated that a greater or lesser number of sensors may be included than that shown in FIG. 1. Sensors 16a-d may be associated with a power source (not shown), a transmission (not shown), a traction device (not shown), a work implement (not shown), and/or other components and subsystems of work machine 10. These sensors may be configured to provide data gathered from each of these components and subsystems such as, for example, engine RPM, oil pressure, water temperature, boost pressure, oil contamination, electric motor current, hydraulic pressure, system voltage, fuel consumption, payload, ground speed, transmission ratio, cycle time, start time, stop time, grade, position and/or location of work machine 10 and a work implement attached to work machine 10, and other such pieces of information. Other pieces of information may be generated or maintained by the interface module such as, for example, time of day and date.

Communication module 18 may include any device that is configured to facilitate communications between controller 22 and off-board system 20. Communication module 18 may include hardware and/or software that enables communication module 18 to send and/or receive data messages through a direct data link 26 or a wireless communication link 28. The wireless communications may include satellite, cellular, infrared, and any other type of wireless communications that enables controller 22 to wirelessly exchange information with off-board system 20.

Off-board system 20 may represent one or more computing systems associated with a business entity corresponding to work machine 10, such as a manufacturer, dealer, retailer, owner, or any other entity that generates, maintains, sends, and/or receives information associated with work machine 10. The one or more computing systems may include a work station, a personal digital assistant, a laptop, a mainframe, and other computing systems known in the art. Off-board system 20 may include any means for receiving work machine operating parameter-related instructions from a user and/or for directly communicating with communication module 18 via data link 26 such as for example, a keyboard 31 and data port 32. Alternately, off-board system 20 may communicate with communication module 18 via antennae 30 and 34 and associated wireless communication hardware through wireless telephone, pages, text-messages, electronic mail, etc.

Controller 22 may include any means for receiving work machine operating parameter-related instructions from off-board system 20 and for monitoring, recording, storing, indexing, processing, and/or communicating work machine operating parameters. These means may include components such as, for example, a memory, one or more data storage devices, a central processing unit, or any other components that may be used to run an application. Controller 22 may include a means for receiving operation related data directly from a work machine operator during operation of work machine 10. These means may include a keyboard, a display system, or any other means known in the art. Controller 22 may be in communication with the various components and subsystems of work machine 10 via interface module 16, with communication module 18, and with identification module 14, via communication lines 36, 38, and 40, respectively. Furthermore, although aspects of the present disclosure may be described generally as being stored in memory, one skilled in the art will appreciate that these aspects can be stored on or read from types of computer program products or computer-readable media, such as computer chips and secondary storage devices, including hard disks, floppy disks, optical media, CD-ROM, or other forms of RAM or ROM. Various other known circuits may be associated with controller 22 such as, for example, power supply circuitry, signal-conditioning circuitry, solenoid driver circuitry, communication circuitry, and other appropriate circuitry.

### INDUSTRIAL APPLICABILITY

The disclosed data acquisition system may be applicable to any work machine where it is advantageous to index captured work machine operating parameters with particular machine operators. Work machine performance evaluation based on operator-indexed information may allow for efficient deployment of personnel and equipment resources. In addition, tracking machine usage and operation according to the operator may facilitate appropriate directing of charges associated with operation of the work machine. The operation of data acquisition system 12 will now be described in detail.

Data acquisition system 12 may be operator programmable. For example, a list of operating parameters available for monitoring may be stored on a memory of controller 22 and/or off-board system 20. Before and/or during data acquisition sessions, a machine operator may select which of the parameters in the list of available operating parameters should be recorded and stored by data acquisition system 12. If the operating parameters are selected via off-board system 20, this selection may thereafter be communicated to controller 22 via direct data link 26 or wireless data link 28. For example, from a list having a variety of monitored operating parameters available for recording and storing, a particular operator may decide to only capture information related to fuel consumption such as, for example, total fuel burned, fuel burn rate, etc. By selecting a subset of operating parameters available for acquisition and only recording and storing desired information, computing efforts of controller 22 may be kept to a minimum.

In addition to selecting which parameter to record and store, it may also be indicated how often the parameter should be recorded and stored, and how often the parameter should be reported (transferred). For example, a recording rate of every five minutes and a reporting rate of once per day may be indicated. The recording and reporting rates may be manually entered or selected from available rates stored in a memory of controller 22.

The selection of operating parameters and indicating of recording and reporting rates may be made in several ways. These selections and configurations may be entered into data acquisition system 12 via off-board system 20, as described above. During regularly scheduled or as-needed communications with work machine 10, controller 22 may be updated with new selections and configurations. These selections and configurations may, however, also be entered into data acquisition system manually or automatically via identification module 14. In the case of identification module 14 including a keypad, the selections and configurations may be entered directly into identification module 14. Work machine 10 may also include a display system (not shown), a removable memory reader (not shown), a keyboard, or another means for directly entering the selections and configurations.

In addition, one or more sets of selections and/or configurations may be pre-programmed into the memory of controller 22 for automatic correlation to identification codes of particular operators. Upon entering an operator identification code via identification module 14, controller 22 may automatically change the settings and/or configurations for data acquisition to those settings and configurations already stored in the memory of controller 22 that correspond to the entered code. For example, it may be desired to track work machine idle time when a first operator is using work machine 10, but to track fuel consumption or some other parameter when a second operator is using work machine 10. When an identification code corresponding to the first operator is entered into identification module 14, the settings and/or configurations corresponding to that identification code may be automatically changed. In addition, recording and/or reporting rates may be pre-programmed differently depending on the particular operator.

Controller 22 may also be capable of processing the data captured via interface module 16 according to pre-programmed and/or user entered functions. For example, although total fuel burned and payload may both be operating parameters monitored by controller 22, a particular user may desire to have controller 22 record, store, and report a performance parameter such as gallons of fuel burned per pound of payload transported. This and other functions may be pre-programmed into the memory of controller 22 and available for selection by the operator or manually entered into data acquisition system 12.

Controller 22 may be configured to transfer the recorded, stored, and processed data to off-board system 20 via communication module 18. According to the reporting schedule manually entered and/or selected from a list of available schedules, controller 22 may report the manually entered or selected operating parameters and/or performance parameters to off-board system at regular intervals, during scheduled transmissions, or on an as-needed basis. As described above, the data may be transferred via direct data link 26 or via wireless data link 28. It is also contemplated that the data may be transferred to a removable memory device via a memory writer (not shown) associated with work machine 10.

It will be apparent to those skilled in the art that various modifications and variations can be made to the disclosed data acquisition system without departing from the scope of the invention. Other embodiments will be apparent to those skilled in the art from consideration of the specification. It is intended that the specification and examples be considered as exemplary only, with a true scope of the invention being indicated by the following claims and their equivalents.

1. A data acquisition system for a work machine, comprising:
at least one sensor disposed on the work machine, the at least one sensor configured to produce a signal indicative of an operating parameter of the work machine;
an identification module disposed on the work machine and configured to receive an input corresponding to a machine operator;
a controller disposed on the work machine and in communication with the at least one sensor and the identification module, the controller configured to record and link the signal and the input; and
a communication module disposed on the work machine and in communication with the controller, the communication module configured to transfer the recorded and linked signal and input from the controller to an off-board system.

2. The data acquisition system of claim 1, wherein at least two of the identification module, controller, and communication module are integrated as a single unit.

3. The data acquisition system of claim 1, wherein a plurality of sensors are disposed on the work machine and the controller includes a memory, and the operating parameter is selectable from a list of available monitored operating parameters stored in the memory.

4. The data acquisition system of claim 1, wherein a plurality of sensors are disposed on the work machine and the controller includes a memory, and the operating parameter is automatically selected from a list of available monitored operating parameters stored in the memory in response to the input.

5. The data acquisition system of claim 1, wherein the controller is configured to receive a rate input indicative of a desired recording rate for the operating parameter.

6. The data acquisition system of claim 1, wherein the controller is configured to receive an input related to a desired transfer rate for the operating parameter.

7. The data acquisition system of claim 1, wherein a plurality of sensors are disposed on the work machine and the controller is configured to determine a performance parameter value as a function of one or more signals produced by the plurality of sensors and to transfer the performance parameter to the off-board system.

8. The data acquisition system of claim 7, wherein the controller includes a memory and the performance parameter is selectable from a list of available performance parameters stored on the memory.

9. The data acquisition of claim 7, wherein the performance parameter is automatically selected from a list of available monitored performance parameters stored on the memory in response to the input.

10. The data acquisition system of claim 1, wherein the communication module is configured to wirelessly communicate with the off-board system.

11. A method of acquiring data for a work machine, comprising:
sensing a plurality of operating parameters of the work machine;
receiving an input corresponding to a machine operator; and
recording and linking the plurality of operating parameters and the input.

12. The method of claim 11, further including transferring the recorded and linked plurality of operating parameters and input to an off-board system.

13. The method of claim 11, further including receiving a selection of the plurality of operating parameters from a list of available monitored operating parameters stored in a memory of a work machine controller.

14. The method of claim 11, further including automatically selecting the plurality of operating parameters from a list of available monitored operating parameters stored in a memory of a work machine controller.

15. The method of claim 11, further including:
receiving a desired recording rate for the plurality of operating parameters; and
recording the plurality of operating parameters at the desired recording rate.

16. The method of claim 11, further including:
receiving for each of the plurality of operating parameters a desired recording rate; and
recording the plurality of operating parameters at the desired recording rates.

17. The method of claim 11, further including:
receiving a desired transfer rate for each of the plurality of operating parameters; and
transferring to an off-board system each of the plurality of operating parameters at the desired transfer rate.

18. The method of claim 11, further including:
determining a performance parameter value as a function of one or more of the sensed plurality of operating parameters; and
transferring the performance parameter value to the off-board system

19. The method of claim 18, further including receiving a selection of the performance parameter from a list of available performance parameters stored in a memory of a work machine controller.

20. The method of claim 18, further including automatically selecting the performance parameter from a list of available performance parameters stored in a memory of a work machine controller in response to the input.

21. The method of claim 12, wherein the off-board system is located remotely from the work machine and transferring the recorded and linked plurality of operating parameters and input occurs through one or more wireless transmissions.

22. A work machine, comprising:
a power source;
a work implement; and
a data acquisition system disposed on the work machine, including:
a plurality of sensors disposed on the work machine, each of the plurality of sensors configured to produce a signal indicative of an operating parameter of the work machine;
an identification module disposed on the work machine and configured to receive an input corresponding to a machine operator;
a controller disposed on the work machine and in communication with the plurality of sensors and the identification module, the controller configured to record and link the signal of each of the plurality of sensors and the input;
a communication module disposed on the work machine and in communication with the controller, the communication module configured to transfer the recorded and linked signal and input from the controller to an off-board system.

23. The work machine system of claim 22, wherein the identification module, controller, and communication module are integrated as a single unit.

24. The work machine system of claim 22, wherein the controller includes a memory and the operating parameter is selectable from a list of available monitored operating parameters stored in the memory.

25. The work machine system of claim 22, wherein the controller includes a memory and the operating parameter is automatically selected from a list of available monitored operating parameters stored in the memory in response to the input indicative of a machine operator.

26. The work machine system of claim 22, wherein the controller is configured to receive at least one of a desired recording rate and a desired transfer rate for the operating parameter.

27. The work machine system of claim 22, wherein the controller is configured to determine a performance parameter value as a function of one or more of the signals produced by the plurality of sensors and to transfer the performance parameter value to the off-board system.

28. The work machine system of claim 27, wherein the controller includes a memory and the performance parameter is selectable from a list of available performance parameters stored in the memory.

29. The work machine system of claim 27, wherein the controller includes a memory, and the performance parameter is automatically selected from a list of available performance parameters stored in the memory in response to the input indicative of a machine operator.
